(19) United States
(12) Patent Application Publication
(10) Pub. No.: US 2008/0147519 A1
(43) Pub. Date: Jun. 19, 2008

(54) Method and System for Conducting Inventories and Appraisals

(76) Inventor: Scott Reigel, Lewisburg, WV (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/611,411

(22) Filed: Dec. 15, 2006

(51) Int. Cl. G06Q 10/00

(52) U.S. Cl. 705/28

(57) ABSTRACT

A system and method for conducting an inventory and/or appraisal is disclosed. A grid marked along one direction with increments of one characteristic and along a second direction with increments of another characteristic is electronically displayed by an electronic device. An item is assayed with respect to the two characteristics and the values for those characteristics are communicated to the electronic device by indicating the appropriate cell in the grid. The electronic device increments an integer displayed in the cell to increment the inventory. Different grids can be selected for different types of items. Monetary values can be associated with items and stored in the electronic device to facilitate an appraisal. Multiple portable electronic devices can be used in combination and with a central computer station. The types of items that can be inventoried and appraised are unlimited. Several embodiments are discussed. Some relate to timber.

### FIELD OF THE INVENTION

This invention relates generally to a method of taking an inventory, and of appraising an inventory. More specifically, a method of electronically taking an inventory through the use of a display grid. Additional information is utilized to appraise the inventory. In at least one embodiment, the method is applied to inventorying and appraising the trees on a tract of land. That embodiment is consistent with established methods of conducting an inventory on paper, but is automated. The method is applicable to other types of counting, inventorying, and appraising in addition to tree and forest tract appraisal.

### BACKGROUND OF THE INVENTION

In just about any enterprise, but especially those where money is important, it is frequently necessary to acquire and maintain a count, or inventory, of items. Taking an inventory can be a tedious and time consuming process, in particular, if a variety of items is being inventoried and it is necessary to note specific characteristics or measurements of the items. Any improvement to recording inventory numbers and associated characteristic data would offer desirable increases in efficiencies.

In addition to enterprise related inventories, various counts may also be needed for various types of research and other studies. A person recording the make-up of attendance at an event might need to record several characteristics of each person in attendance as well as a raw count. Someone studying a natural phenomenon such as a geyser field might desire to record a geyser, its height, and its duration. There are countless recording activities that need improved methods of observation recording in order to quickly record quantities and characteristics.

One process in particular that is ready for improvement is the inventorying and appraisal of trees and wooded tracts. Wood, in all its forms, is a very important constituent in modern products. The wood may be used as lumber, veneer, and pulpwood, as well as other uses. Despite the phenomenon of modern tree farming, wild tracts of forests are still cut. To bid on and purchase, or even just study the trees on these wild tracts, it is necessary to conduct an inventory of the species of trees and the respective quantities of wood for each species on a tract of land. The values associated with the species of the trees inventoried allows an appraisal to be made. A term of art for inventorying trees on a tract of land is timber cruising.

One established method of inventorying a tract of land is the dot tally method. This method uses a grid system wherein, a sheet of paper with a grid on it is devoted to each specie of tree that will be counted on the tract. On each grid, one edge is labeled with increments of diameters of the trunks, while the other edge is labeled with increments of length measurements of the trunks. When a tree of a given specie is counted, a mark is made on the appropriate sheet in the grid cell corresponding to the appropriate diameter and appropriate length measurement. For the forestry industry these measurements are standardized in several ways.

The length measurement units frequently used are Merchantable Heights, which are based on 16 foot logs. A tree that is measured to have 24 feet of usable, or merchantable trunk, will be recorded in a cell for 1½ Merchantable Heights, and the appropriate diameter. A parameter common to forestry operations is the DBH, or Diameter at Breast Height which is defined as the diameter of the tree at 4½ feet off of the ground. If the ground is sloped, measurement of DBH should be 4½ feet off of the ground on the uphill side. The actual units of this parameter are standard linear units such as feet and inches, but the DBH gives a standard location for taking the measurements.

Once a count of trees on a tract of land is recorded, the data is used to calculate the volume of the various species of wood. Tree trunks are not perfect cylinders, but rather have a taper, the rate of which varies from specie to species. Industry standard tables indicate the rate of taper for various species, and this information is used to calculate the amount of wood expected in a tree of a given specie, diameter, and linear measurement. The quantities and sizes in the dot tally are used along with the information in the tables to determine the volume, or board feet, of each specie of tree found on the tract of land. In addition to board feet, the volume may be calculated in terms of pulpwood tonnage, or veneer. After the volumes of the various species are calculated, the relative value of each type of wood may then be used to calculate an estimate of the value of the standing timber on the tract of land. This information is then used for various business decisions. While this is an established and accepted procedure for appraising a stand of timber or the land on which it stands, it is also a time consuming process. There is a need for more direct information collation and faster processing of gathered information. Also, there is a need for a more robust and hardy recording method that does not require the use of paper out in the elements.

### DESCRIPTION OF PRIOR ART

U.S. Pat. No. 6,708,114 B1 by Milligan is a patent for a timber cruising method and system utilizing a GPS component. The method relies upon statistical methods and consists of defining a plurality of plots within a cruised region. Destination points are selected within those plots and a route is defined to reach those selected points. A portable navigation system, such as a GPS system, is used to guide a forester to each point and when the forester reaches that point, the system will alert him that he is near the point. Once at the point, the forester will record information and data about the trees and other land features near him to be entered into the system. Statistical methods are used to apply this information to the overall plot within which the point is located. The statistical methods are further used to characterize the overall tract of land being inventoried. The system provides for a data link between a portable computing device into which the forester enters the information and a larger system. The portable device and the larger computer system are capable of correlating the data and the locations, and this is the crux of this invention. The actual statistical methods and applications are not immediately claimed in this patent.

U.S. Pat. No. 6,738,148 B2 by Dunn et al., is a patent for measuring a tree, in particular, the diameter of the tree. The claimed device has a display through which a tree, or as it is claimed, a conical object, may be observed. Upon this display are brackets which may be brought into alignment with the left and right sides of the conical object being observed. The device also has an inclinometer for determining the vertical angle of the object being measured. Along with these elements, a processor is included to take the measurements provided by the inclinometer and the user adjusted brackets to calculate the diameter and volume based upon a known distance from the user and the object being measured. An alternative embodiment of this invention provides the means for determining the height at which a specified diameter occurs. The brackets are aligned with the tree as in the previous embodiment and calculations by the processor also included in this embodiment, along with the inclinometer calculates the height at which a specified diameter would occur based on the measurements of the brackets, the inclinometer, and a known distance from the object to the observer.

### SUMMARY OF THE INVENTION

The present invention utilizes grids displayed on an electronic display device and an associated processor to conduct an inventory. In a particular application, the grids are used to inventory and appraise a tree or group of trees as might be found on a forest tract. In this embodiment, measurements of a tree, or trees, are entered into a processor and these measurements along with other information associated with the specie of the tree are used to appraise the tree or group of trees. In one embodiment the electronic display device is touch sensitive and parts of the method can be accomplished by touching the screen.

For each individual tree, a person determines the diameter, specie, and the length of merchantable timber presented by the tree. The diameter is typically specified to be the Diameter at Breast Height, or DBH, which is the diameter of the tree at 4½ feet off of the ground on the up hill side of the trunk. The length units in commercial timber is frequently the Merchantable Height which is defined as a section of log 16 feet in length. The specie of the tree indicates the values for several parameters such as the typical taper of the trunk in that specie of tree. The current monetary value of pulpwood, of veneer, or of a board foot volume, may also be associated with the species. Units such as DBH and Merchantable Heights are typical to the forestry industry and the one embodiment of the invention uses them for common convenience, but the specific units are not required to accomplish the method and should not be regarded as limiting the invention.

The grid displayed on the electronic visual display device is labeled along one direction with diameter increments and along a second direction with length increments. Touching the touch sensitive screen in a grid cell associated with the determined measurements, communicates this information to the processor. The specie of the tree may be communicated by which grid is chosen to be displayed. The processor then uses this information along with information associated with the specie to appraise a particular tree. For the purpose of timber cruising the process is repeated for each tree that is desired to be inventoried on the tract, and information is updated on the screen as individual trees are added to the count. Each time a cell is touched the number displayed in that cell updates and increments by one. The touch screen can display other updated information such as the value and quantity of board feet, tons of pulpwood, or veneer for each species.

Because timber cruising is done on location, frequently in rough terrain, an embodiment that utilizes hand held electronic devices has additional utility. Theses devices may have the ability to appraise the timber, or they may be used as simple information storage and transmission devices. In the latter case, the information is later transmitted to a central processor which then appraises the timber. Also several handheld devices can be used on a given tract and be capable of combining their collected information when the tract is finished. The same hand held electronic device may be used in different modes with the different operation being a function of the individual operator or the business practice of the business deploying the devices for timber tracking.

The grid system described above in reference to timber cruising has other applications. Any need to count items with speed and to record item characteristics will benefit from the system. Some embodiments will be further discussed in the detailed description section.

### BRIEF DESCRIPTION OF THE DRAWINGS

Additional utility and features of the invention will become more fully apparent to those skilled in the art by reference to the following drawings, which illustrate the primary features of the preferred embodiment.

FIG. 1 shows an embodiment of the present invention adapted to forest inventory.

FIG. 2 shows the embodiment of FIG. 1 with calculated information displayed.

FIG. 3 shows a different area of the view shown in FIG. 2.

FIG. 4 illustrates the interaction and communication between elements of one embodiment of the invention.

FIG. 5 shows a embodiment directed to another type of inventory.

FIG. 6 shows an embodiment of the invention directed toward recording events.

FIG. 7 shows an embodiment of the invention directed toward recording the presence and type of objects.

### DETAILED DESCRIPTION OF THE PREFERRED EMBODIMENT

The detailed description below is for embodiments intended to illustrate and explain the current invention. It is to be understood that a variety of other arrangements are also possible without departing from the spirit and scope of the invention. Where appropriate, the same numbering will be used when discussing different embodiments.

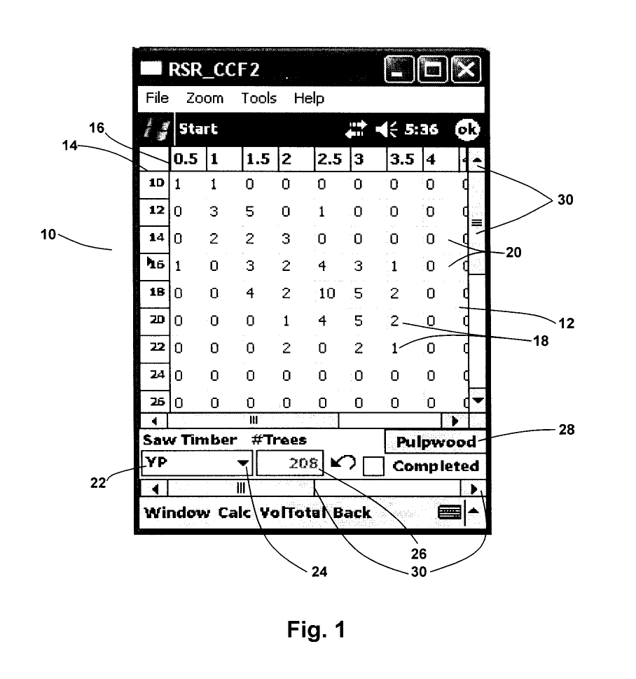

FIG. 1 shows an embodiment of the current invention oriented toward inventorying and appraising trees and forest tracts. The timber cruise interface 10 includes several features, central among which is grid 12, labeled along a first direction 14 indicating increments of diameters of trees and along a second direction 16 with increments of lengths of trees. Integers 18 within cells 20 of grid 12 indicate the current count of trees having the corresponding diameter length measurements. Grid identifier 22 indicates the specie of tree and is selected from a grid identifier pull down menu 24 to select the appropriate grid for a tree being inventoried and appraised. The specie count is displayed at 26 in the specie count field. Additional calculated quantities can also be displayed such as pulpwood tonnage 28 as partially shown at the lower right. In the embodiment shown, grid 12 may be shifted by using slides 30 which are common in graphical interfaces. This embodiment also utilizes a portable computing device to display the various interface screens and collect data.

To inventory a tree, its specie, diameter measurement, and length measurement are determined, the correct grid for the specie is selected at 22 and 24, and the appropriate cell 18 communicated to the system. The appropriate cell 18 may be selected by several means common in computers and other electronic devices. One embodiment utilizes an electronic display device that is contact sensitive. Contacting the grid 12 in the cell 20 corresponding to the correct measurements communicates to the system the measurements for a tree being inventoried, and selecting which grid is displayed communicates the specie of the tree. Other methods common to computers such as navigating with arrows, clicking with a mouse and cursor, or entering cell coordinates are used in other embodiments.

Once the portable computing device receives the information specific to a tree, it has the capacity, with stored information relating to each specie, to make several calculations and provide the information in the field. The calculations for each tree are added to running totals for the current tract of land. Values that may be calculated include: the quantity of board foot for each specie that will be used for lumber; tons of pulp for each specie that will be used for paper; multiple logging costs; stumpage value of the standing trees; the percent of specie usable as veneer; the amount of standing trees usable for veneer; the woods delivered sales value; and the profit or loss associated with harvesting the tract, as well as many other values. When the purpose of inventorying the forest tract is to offer a price for the wood on the tract, this on-the-spot processing allows an offer to be made immediately upon finishing the inventory.

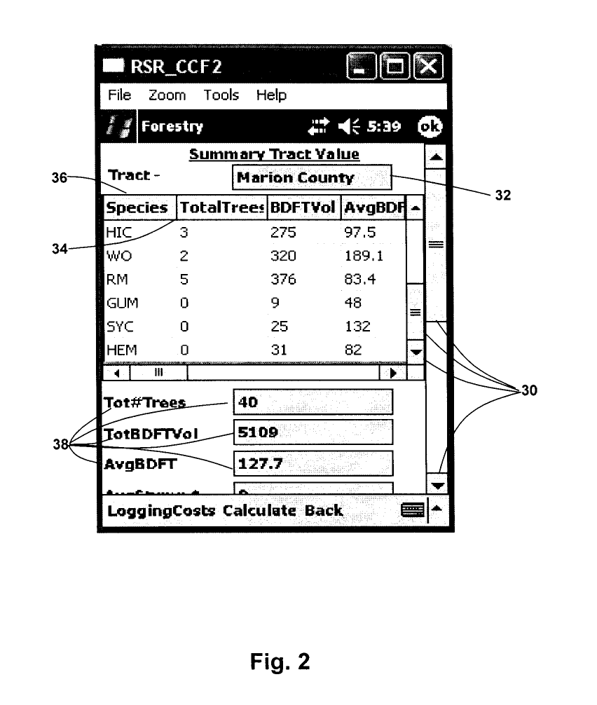

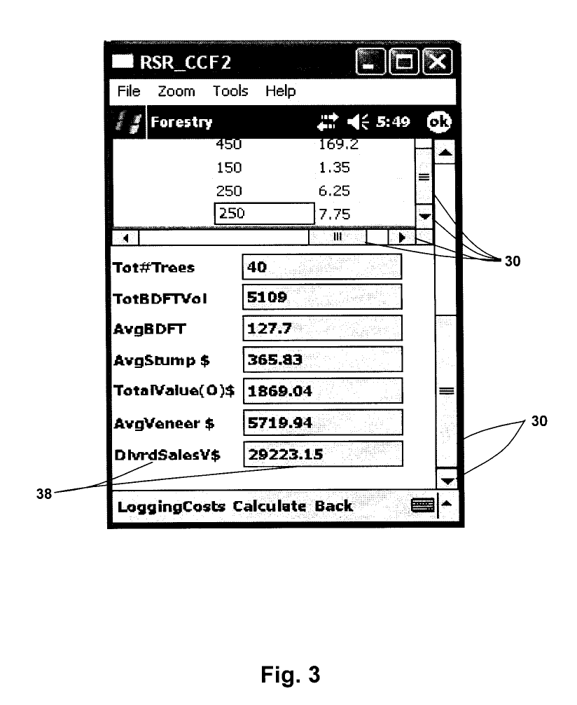

FIG. 2 shows the display of the information compiled from entries into the system using the display of FIG. 1. The tract of land inventoried and appraised is identified in the tract field 32. A specie table 34 lists quantities for each specie encountered in the inventory process. Specie column 36 lists the species while the remaining columns list the calculated values for each specie resulting from entered data and accepted formulas in the forestry industry. The information that can be calculated and displayed includes total trees for a specie, total board foot for a specie, the average board foot for trees of a specie, average stump value for the trees of a specie, total value of trees of a specie, average veneer value for trees of a specie, and delivered sales values of the trees of a specie. At the bottom a FIG. 2 are listed tract values 38 for the entire tract. These values are totals, or averages, from all the individual species in most cases. FIG. 3 shows the bottom of the listing of tract values 38. The additional visible tract values 38 are made visible by shifting the display using slides 30, a common functionality of graphical computer displays.

Referring again to FIG. 1, grid 12 is labeled along a first direction 14 indicating increments of diameters of trees. The units in the embodiment are inches. A common accepted convention for measuring diameters in the timber industry is “Diameter at Breast Height” or DBH. This is the diameter of the tree, as measured, at 4½ feet off of the ground. If the ground is sloped, measurement of DBH should be 4½ feet off of the ground on the uphill side. The display of grid 12 can be shifted down by using arrows 30 to reveal a selection of larger diameters to enter. Along a second direction 16, grid 12 is labeled with increments of lengths of trees. In this embodiment, the units are in Merchantable Heights which is also a conventional unit in the timber industry. Merchantable Heights are based on 16 foot logs. The display of grid 12 can be shifted right by using arrows 30 to reveal a selection of more length measurements in Merchantable Heights to enter. While these units are common for the timber industry, they should not be viewed as a requirement for this invention, and users can define their own units if they so desire. Also, the shifting of the view is a function of the size of the display area and would not be required for embodiments having larger screens or showing a more limited display.

Along with the units DBH and Merchantabile Height, there are calculated quantities commonly used in the timber industry which are calculated based on the measurement of diameter and length measurement and the particular specie of tree. These calculated quantities include board feet, average board foot, stump value, value, total value, average veneer value, and delivered sales value. Different species of trees have varying characteristics that effect these calculations. For example, the rate of taper of a tree trunk varies from specie to specie. This rate of taper is established industry references and utilized to calculate the volume of wood in a tree based on formulas commonly used in the industry. The inherent monetary value of the wood of a specie will effect the appraised value of a tree as well. The value of the wood is determined by market matters, etc. All of this specie specific information is made available to the portable computing device which uses the entered information of diameter, length measurement, and specie, the industry standard values for species, and the industry standard formulas to calculate the desired quantities and values. In one embodiment a user may vary the specie specific information from the industry standard values. A user may want to do this based on their personal knowledge of specie growth in their geographic area, on an end customers agreed prices, or on other factors.

The method and apparatus may be used with a single tree, the entirety of a single tract, or used to inventory and appraise multiple tracts and combine the results. When at least one tract is being inventoried and appraised, there are several methods of doing it, some of which employ statistical methods common in the industry. A mathematically simple method is to inventory every tree. Other options include methods of sampling the tract. In one sampling method, a number of point locations are preselected. The number is based on the size of the tract and other factors. Within a predetermined radius of each point, every tree is sampled, and the resulting inventory is statistically projected onto the entire tract. This is a far less physically onerous method, and it along with other sampling methods are utilized within the timber industry. Embodiments of the present invention are capable of the industry accepted statistical methods, 100 percent count methods, and other methods of inventorying and appraising timber tracts.

Large tracts of forest may require more than one person to complete a timely inventory of a tract. The automated data collection of the present invention allows an operator of a single portable computing to device make entries that others call out as well as those observed by the operator. In addition to that method of operation, more than one portable computing device may be used on a tract of land. The devices can communicate with each other via standard file transfer protocol to consolidate the information. The information for a tract of land can then be evaluated to make a price offer or put to whatever the current intended use is.

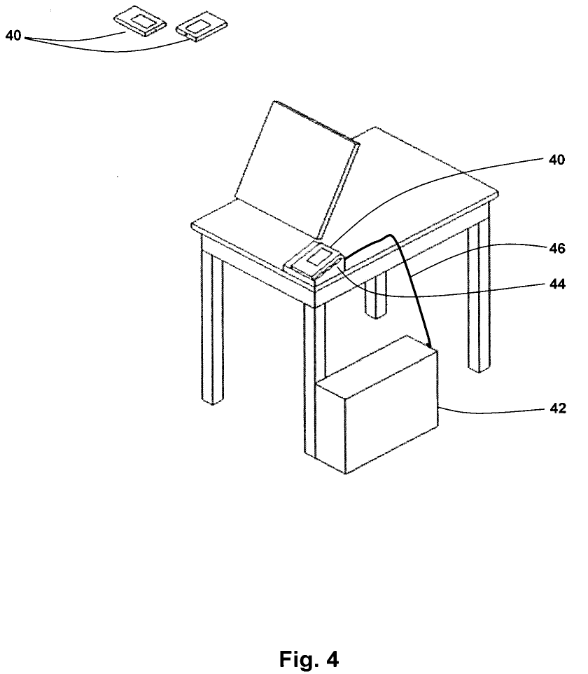

In addition to being able to communicate with each other, the portable computing devices can communicate with a central computer in the several ways available to computing devices in general. FIG. 4 illustrates the ability of the portable computing devices 40 and the central computer 42 to communicate with each other. To the left, two portable computing devices 40 communicate via optical file transfer protocol. To the right, central computer 42 has a cradle 44 attached to it via cable 46. Portable computing device 40 rests in cradle 44 and communicates to central computer 42 over cable 46.

Central computer 42 is more suited for long term database storage than portable computing device 40. Information that is more appropriate to be stored in central computer 42 includes landowner information, legal information, histories of tracts including previous bids and harvests, information about consulting agents, etc. Central computer 42 also provides operating functionality with respect to scheduling, mapping of sample points in tracts, adjusting logging costs, programming of portable computing devices 40 including adjusting parameters for tree species, etc. Specie parameters that might be varied via central computer 42 include trunk taper, stumpage values, veneer values, veneer percent, Central computer 42 can also communicate with other central computers to share information for scheduling and other purposes. Of course, security measures typical of computers and computer file transfers are easily used with and incorporated into the embodiments of the present invention.

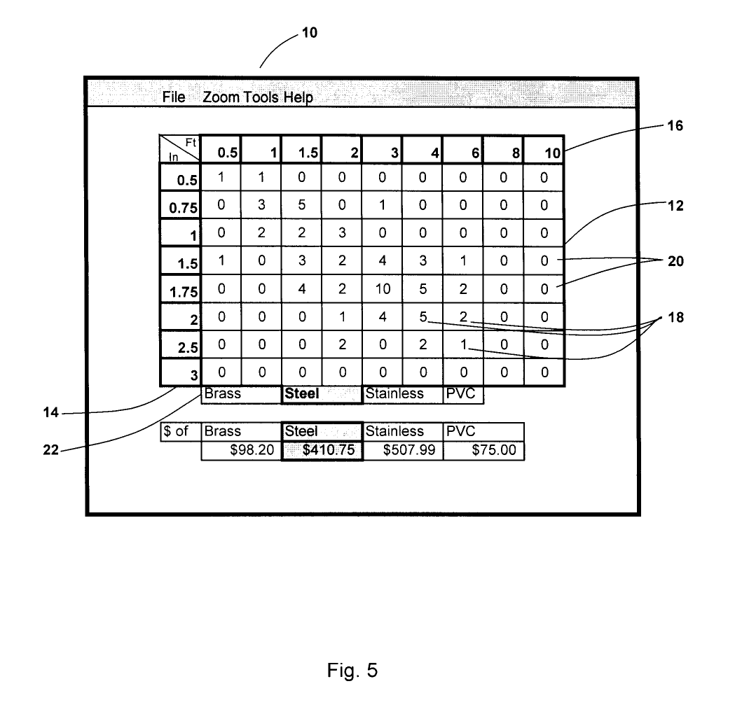

FIG. 5 illustrates another embodiment of the present invention. This embodiment is for inventorying plumbing parts. Grid 12 is labeled along a first direction 14 indicating increments of diameters of pipes and along a second direction 16 with increments of lengths of pipes. Grid identifier 22 shows the type of material of which the piping is made. Note, in this embodiment that grid identifier 22 is located on a tab, and grid 12 may be changed by selecting a different grid identifier tab 22. By storing the monetary values of the different possible pipes, an appraisal of the inventory can also be performed. In general, this embodiment shows how the invention may be adapted to a large variety of inventories and appraisals. As with the timber inventory and appraising embodiment, an associated central computer can supply greater database capabilities and the ability to vary the programming of a portable computing device.

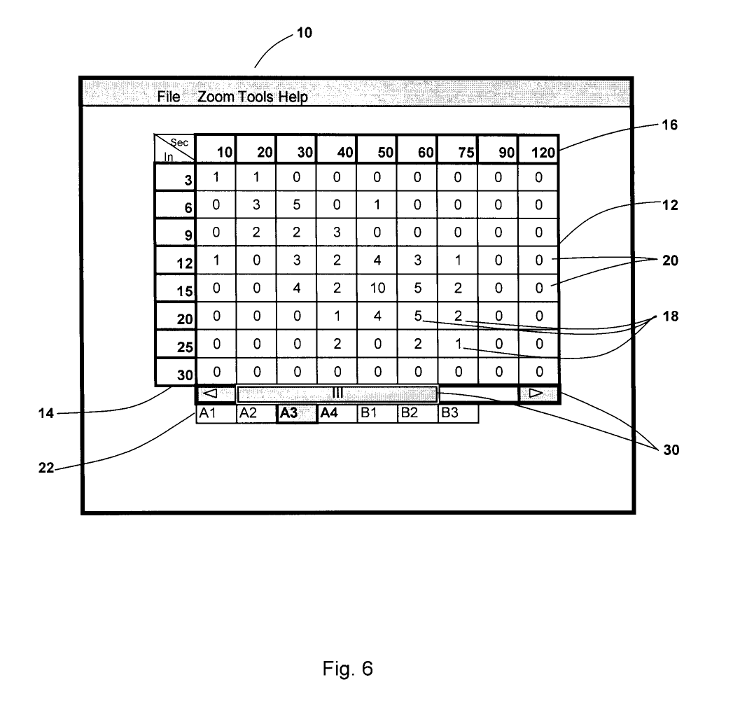

FIG. 6 illustrates another embodiment of the present invention. This embodiment illustrates the ability of the present invention to be applied to recording events, in this case geyser events in a geothermal field. Grid 12 is labeled along a first direction 14 indicating increments of estimated heights of eruptions and along a second direction 16 with increments of duration of eruptions. Grid identifier 22 shows the particular geyser being recorded. Again in this embodiment grid identifier 22 is located on a tab, and grid 12 may be changed by selecting a different grid identifier tab 22. The invention can also be applied in embodiments counting other types of events, such as gestures in social settings, etc. Of course this would require a change of labeling suitable to the events being documented. As with previous embodiments, an associated central computer can supply greater database capabilities and the ability to vary the programming of a portable computing device.

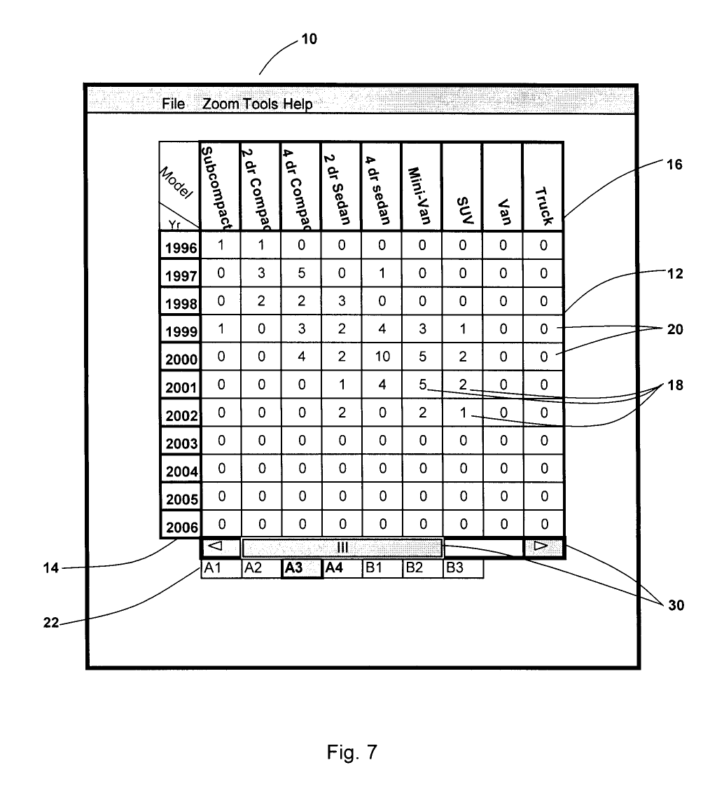

FIG. 7 illustrates another embodiment of the present invention. This embodiment illustrates the ability of the present invention to be applied to various types of census or traffic studies. The embodiment shown is for studying traffic in a parking lot, grid 12 is labeled along a first direction 14 indicating increments of the year of a car, and along a second direction 16 with car models. Grid identifier 22 shows the make of the car being recorded. In this embodiment grid identifier 22 is located on a pull down menu, and grid 12 may be changed by activating a pull down menu and selecting a different make of car. Similarly the invention could be employed to record age, sex, and species for wildlife studies, or age and sex for studying pedestrian traffic through a store, etc. As with previous embodiments, an associated central computer can supply greater database capabilities and the ability to vary the programming of a portable computing device.

The embodiments discussed herein are not intended to be an exhaustive listing of the possible embodiments of the present invention. They are intended to be illustrative of the present invention and the many possible applications of the invention. The embodiments discussed should therefore not be regarded as limiting the scope of the invention.

Also, when the computer-executable instructions of the current invention are stored, the invention is not limited to storage on a particular type of medium. It may be stored on virtually any kind of computer memory. Such computer memory may include floppy disks, conventional hard disks, CD-ROM, Flash ROMS, non-volatile ROM, RAM, and CD-RW.

I claim:

1. A method of inventorying at least one item, comprising:
displaying a grid defining cells on an electronic device, said grid being labeled along a first direction with indications of variations of a first characteristic of said items, and labeled along a second direction with indications of variations of a second characteristic of said items, and;
determining a second value for said second characteristic of one of said items;
determining a first value for said first characteristic of one of said items;
communicating said first and second values for one of said objects to said electronic device by indicating which cell of said grid corresponds to said first and second values, and;
repeating for each of said items that it is desired to inventory.

2. The method of claim 1, further, comprising;
a number displayed in each said cell of said grid, the number in a cell incrementing when said cell is indicated.

3. The method of claim 1, further comprising;
determining a third value for a third characteristic of one of said items, and;
selecting from among several grids that may be displayed for each type of said at least one item, the grid selected communicating to said electronic device said third value for said third characteristic.

4. The method of claim 1, wherein;
said at least one item is selected from the group consisting of;
animal, plant, manufacture, and event.

5. The method of claim 1, wherein;
said characteristics are selected from the group consisting of;
quality, mass, length, size, color, model, sex, and specie.

6. A method of appraising at least one item comprising:
the method of claim 1,
and further comprising,
storing information in said electronic device relating either, or both, of said first and second characteristics to monetary value, wherein;
said electronic device calculates a value for each at least one item based on said first and second values indicated for each item.

7. A method of appraising at least one item comprising:
the method of claim 3,
and further comprising,
storing information in said electronic device relating any, or all, of said first, second, or third characteristics to monetary value, wherein;
said electronic device calculates a value for each said at least one item based on said first, second, and third values indicated for each item.

8. The method of claim 3, wherein;
said at least one item comprise a tree, or trees.

9. The method of claim 8, wherein;
said first characteristic is a diameter measurement;
said second characteristic is a length measurement;
said third characteristic is tree specie;
said electronic device has specie specific information stored in it, and;
said electronic device uses said specie specific information to calculate an inventory in board feet, pulp wood tonnage, or veneer.

10. The method of claim 9, wherein;
said diameter measurement is Diameter at Breast Height, and said length measurement is Merchantable Heights.

11. A method of appraising one, or more trees, comprising;
the method of claim 9, wherein said specie specific information further comprises a monetary value associated between each said specie and at least one of the inventory units, said electronic device using said monetary values to appraise at least one of said trees.

12. A method to inventory and/or appraise, a wooded tract, comprising;
the method of claim 11, and further comprising;
a) selecting 100 percent of said trees on said tract meeting a predetermined specification, and summing their results, or;
b) performing a point sample selection and using the results to project an inventory or appraisal for the entire tract.

13. The method of claim 1, wherein;
said electronic device is hand portable.

14. The method of claim 13, wherein;
more than one hand held electronic device is used, and their individual inventories combined for a total inventory.

15. The method of claim 1, wherein;
communicating said first and second values for one of said items to said electronic device by indicating which cell of said grid corresponds to said first and second values is accomplished by one of the following methods;
a) displaying said grid on a contact sensitive electronic display and directly contacting said cell;
b) navigating said grid with directional keys, and;
c) navigating said grid with a directional interface device.

16. A computer-readable medium having computer-executable instructions for performing a method of inventorying at least one item, said method comprising:
displaying a grid defining cells on an electronic device, said grid being labeled along a first direction with indications of variations of a first characteristic of said items, and labeled along a second direction with indications of variations of a second characteristic of said items, and;
determining a second value for said second characteristic of one of said items;
determining a first value for said first characteristic of one of said items;
communicating said first and second values for one of said objects to said electronic device by indicating which cell of said grid corresponds to said first and second values, and;
repeating for each of said items that it is desired to inventory.

17. A computer-readable medium having stored thereon a data structure for inventorying timber comprising:
a first field containing data representing different species of trees;
a second field containing data representing diameter measurements of at least one tree;
a third field containing data representing length measurements said at least one tree;
a fourth field containing data representing quantities of said at least one tree, and;
a fifth field containing data relating data stored in said first, second, and third fields to the quantity of a tree of particular specie and measurement.

18. The computer-readable medium having stored thereon the data structure of claim 17 further comprising;
a six field containing data representing the monetary value by quantity of species of trees;
a seventh field containing data representing the usable quantity of each specie of tree inventoried up to the current point on a tract of land, and;
an eighth field containing data representing the monetary value of the usable quantity of each specie of tree inventoried up to the current point on a tract of land.

19. A system for inventorying at least one item, comprising:
a storage device;
an electronic display device,
a processor programmed to:
display a grid defining cells on said electronic display device, said grid being labeled along a first direction with indications of variations of a first characteristic of said items, and labeled along a second direction with indications of variations of a second characteristic of said items;
receive information indicating which cell of said grid corresponds to values for said first characteristic and said second characteristic of an object to be inventoried;
increment a count based on said received inventory;
maintain in said storage device a database of quantities of items inventoried.

20. The system for inventorying at least one item of claim 19, wherein:
said at least one item are trees;
said first characteristic is a diameter measurement;
said second characteristic is a length measurement;
and wherein said processor is further programmed to:
receive information indicating the specie of a tree being inventoried;
display a grid associated with said indicated specie of tree;
maintain in said database tree species and parameters for each tree species, said parameters relating said diameter measurement and said length measurement to usable quantity in a tree of given specie, diameter measurement, and length measurement;
calculate a usable quantity for each tree indicated, and;
maintain in said storage device a total of trees inventoried by specie and a total of their usable quantity by specie.

21. A system for appraising at least one tree, comprising:
the system of claim 20, wherein;
said processor is further programmed to:
maintain in said database information relating said species of trees to monetary value;
appraise the value by specie of said usable quantity;
appraise the value of usable quantity of all trees inventoried, and;
maintain said appraisals in said database.

22. The system for appraising trees of claim 21, wherein;
said storage device, processor, and electronic display device are hand portable;
said system further comprises a central processor, central storage device, and a central electronic display device, and;
said processor is capable of communicating with said central processor.
